(19) United States
(12) Patent Application Publication
(10) Pub. No.: US 2011/0270892 A1
(43) Pub. Date: Nov. 3, 2011

(54) Application Network Storage

(75) Inventors: Randy Yen-pang Chou, San Jose, CA (US); John Richard Taylor, Tiburon, CA (US)

(73) Assignee: PIXEL8 NETWORKS, INC., Menlo Park, CA (US)

(21) Appl. No.: 12/772,917

(22) Filed: May 3, 2010

(51) Int. Cl. G06F 9/46; G06F 17/30

(52) U.S. Cl. 707/802; 719/328; 707/E17.044

(57) ABSTRACT

An application programming interface (API) interfaces to an application having a data file of an arbitrary size. The application has parameters characterizing the application. An externalizing provider externalizes the data file. An application network storage (ANS) subsystem saves the data file according to the parameters of the application and the arbitrary size of the data file.

### TECHNICAL FIELD

The presently disclosed embodiments are directed to the field of network, and more specifically, to network storage.

### BACKGROUND

Demands in high performance and high availability applications in enterprise environments have created many opportunities in network storage. Over the last few years network storage has been comprised of two major types: Storage Area Network (SAN) and Network Attached Storage (NAS). A SAN essentially presents itself as block of data to an operating system and servers make use of their own file systems which in turn use the SAN's data blocks. The other type of network storage is a NAS. NAS typically runs its own file system and allows operating systems to make use of its storage through protocols such as Network File System (NFS) and Common Internet File System (CIFS).

SAN and NAS each have its own benefits with SAN being predominantly used for databases whereas NAS are typically used for unstructured data. However, both SAN and NAS have significant overhead in communication with the application. The high overhead limits the speed and reliability of the storage in high availability (HA) applications.

### SUMMARY

One disclosed feature of the embodiments includes techniques for application network storage (ANS). An application programming interface (API) interfaces to an application having a data file of an arbitrary size. The application has parameters characterizing the application. An externalizing provider externalizes the data file. An ANS subsystem saves the data file according to the parameters of the application and the arbitrary size of the data file.

### BRIEF DESCRIPTION OF THE DRAWINGS

Embodiments may best be understood by referring to the following description and accompanying drawings that are used to illustrate embodiments of the invention. In the drawings.

FIG. 1 is a diagram illustrating a system according to one embodiment.

FIG. 2 is a diagram illustrating an externalizing provider according to one embodiment.

FIG. 3 is a diagram illustrating an ANS subsystem using daisy chain saves according to one embodiment.

FIG. 4 is a diagram illustrating an ANS subsystem using individual saves according to one embodiment.

FIG. 5 is a diagram illustrating a remote synchronizer according to one embodiment.

FIG. 6 is a diagram illustrating a process to use the ANS according to one embodiment.

FIG. 7 is a diagram illustrating a process to externalize according to one embodiment.

FIG. 8 is a diagram illustrating a process to communicate according to one embodiment.

FIG. 9 is a diagram illustrating a process for remote synchronization according to one embodiment.

FIG. 10 is a diagram illustrating a processing system for the front end Web server according to one embodiment.

### DETAILED DESCRIPTION

One disclosed feature of the embodiments includes techniques for application network storage (ANS). An application programming interface (API) interfaces to an application having a data file of an arbitrary size. The application has parameters characterizing the application. An externalizing provider externalizes the data file. An ANS subsystem saves the data file according to the parameters of the application and the arbitrary size of the data file.

The externalizing provider saves the externalized data file to the ANS subsystem and transmits one single acknowledgment from the ANS subsystem to the application. The one single acknowledgment corresponds to the data file. By sending only one acknowledgment for the entire data file instead of multiple acknowledgements for multiple blocks of data in the data file, significant saving in transmission overhead may be achieved, resulting in a high availability (HA).

A snapshot of information may be taken and transmitted from a first ANS unit to a second ANS unit. This may allow a remote user to obtain the information from the second ANS unit even when connectivity between the first and second ANS units is down. The snapshot of information may include metadata and data and may be taken incrementally. The metadata and data may be taken and transmitted separately.

In the following description, numerous specific details are set forth. However, it is understood that embodiments of the invention may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

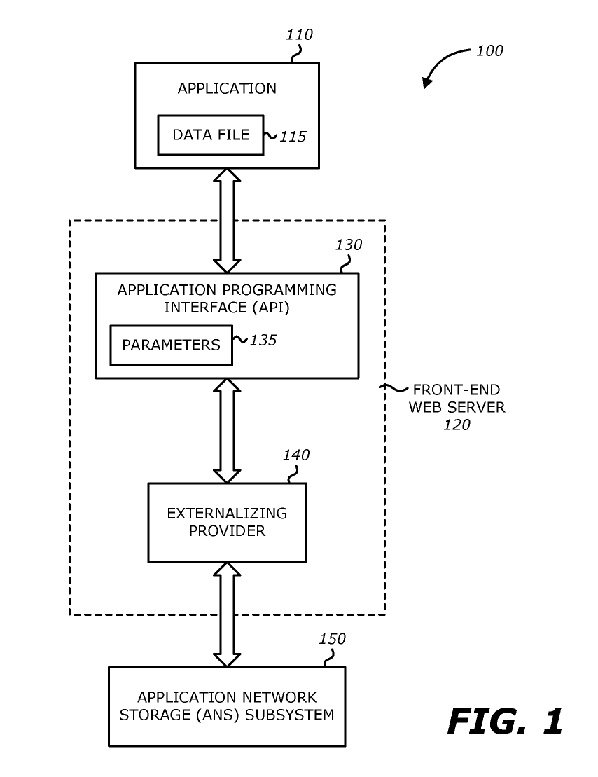

FIG. 1 is a diagram illustrating a system 100 according to one embodiment. The system 100 includes an application 110, a front-end Web server 120, and an application network storage (ANS) subsystem 150. It is noted that the system 100 may include more or less than the above elements.

The application 110 may be any application that uses the ANS subsystem. Typically the application 110 may be a database application where a large amount of data needs to be saved or processed. For example, the application 110 may have a data file 115 that may need to be saved or transmitted to the ANS subsystem 150. The data file 115 may have an arbitrary size. The size may be extremely large, typically in the order of Megabytes (MBs) or Gigabytes (GBs). The data file 115 may be any type of data. It may be a Binary Large Object (BLOB). The application 110 may have parameters that characterize the application. These parameters provide information on which the application 110 may be processed or understood.

The front-end Web server 120 may be any server that may have access to the Web via connectivity to a network. The network may be a local area network, a wide area network, an intranet, or the Internet. An appropriate Web browser is available for a user of the Web server 120 to log onto the Web. The front-end Web server 120 may be loaded with an application programming interface (API) 130 and an externalizing provider 140. The front-end Web server 120 may include more or less than the above components. For example, the API 130 and the externalizing provider 140 may be combined into one integrated module.

The API 130 interfaces to the application 110. The API 130 is designed to be compatible with the application 110 and its characteristics. The API 130 obtains the parameters 135 from the application. The parameters 135 may contain useful information for the API 130 to process the data file 115. For example, they may include the size and format of the data file, the compression algorithm, the metadata, or any other useful information. From the parameters 135, the API 130 may be able to identify and obtain the data file 115.

The externalizing provider 140 externalizes the data file 115 as directed by the API 130. The externalizing provider 140 may be implemented using tools or development systems provided by Microsoft, Oracle, or any other third-party vendors. In one embodiment, the externalizing provider 140 uses the External BLOB Storage (EBS) or Remote BLOB Storage (RBS).

The ANS subsystem 150 may be a storage device, an array of storage, or multisite storage units. It may include a single local storage or a network of storage populated across a network. The storage device may be any suitable storage device. Examples of the storage device are Advanced Technology Attachment (ATA) (parallel and/or serial), Integrated Drive Electronics (IDE), enhanced IDE, ATA Packet Interface (ATAPI), Fiber Channel (FC), Redundant Inexpensive/Independent Disks (RAIDs), etc. The ANS subsystem 150 may save the data file 115 according to the parameters of the application and the arbitrary size of the data file 115. Since the API 130 understands the application 110 and the data file 115, the storing of the data file 115 in the ANS subsystem 150 may be performed with high efficiency. For example, the externalizing provider 140 may return a single acknowledgment back to the application 110 after the data file 115 is stored in its entirety instead of multiple acknowledgements after each block of fixed size of data in the data file 115 is saved. In the prior art systems, an acknowledgement is sent after a block of data of a predetermined fixed size is saved. This involves the sending of the acknowledgement itself and the time for the application to be idle while waiting for the acknowledgement. Typically, the number of acknowledgements in the prior art systems may be quite large. For example, for a block size of 16 Kilobytes (KBs) and a file size of 1 MB, the total number of acknowledgements for a two-HA system is 130. Here, the externalizing provider 140 sends only one acknowledgement for the entire file, regardless of the file size. By reducing the overhead in handshaking or acknowledgements, high throughput of data saving may be achieved, resulting in high availability (HA).

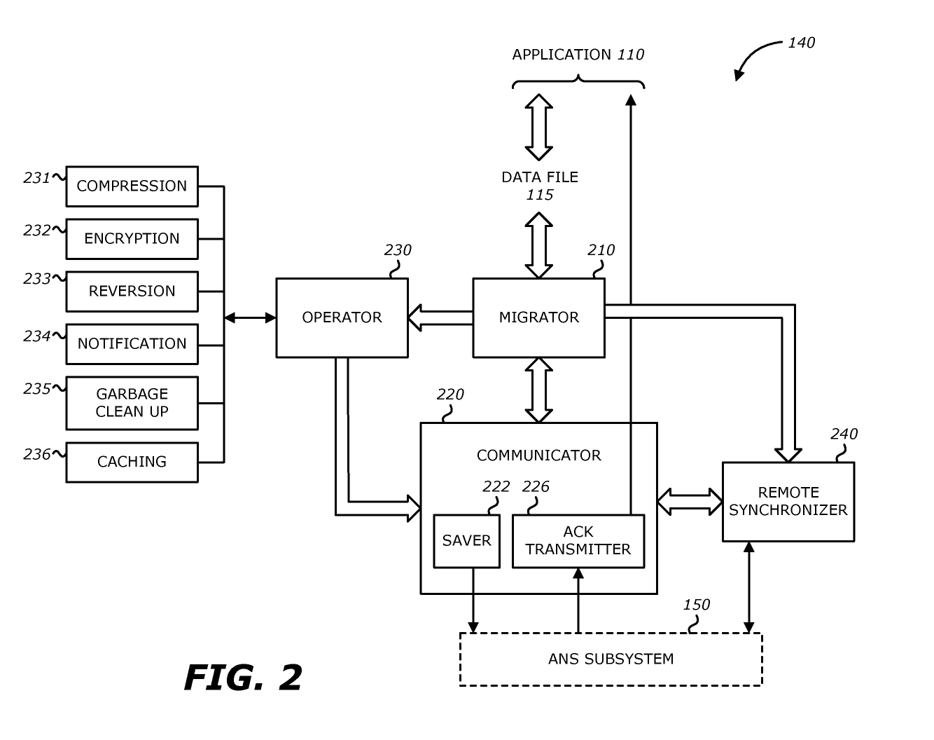

FIG. 2 is a diagram illustrating the externalizing provider 140 shown in FIG. 1 according to one embodiment. The externalizing provider 140 may include a migratory 210, a communicator 220, an operator 230, and a remote synchronizer 240. The externalizing provider 140 may include more or less than the above components.

The migrator 210 migrates the data file 115 from the application 110 as directed by the API 130. This may involve extracting the data file 115 based on the parameters 135 and passing the data file 115 to the communicator 220, the operator 230, or the remote synchronizer 240.

The communicator 220 communicates with the ANS subsystem 150. It may initiate a storing or saving operation on the ANS subsystem 150. It may include a saver 222 and an acknowledgement (ACK) transmitter 226. The saver 222 saves the externalized data file 115 to the ANS subsystem 150 according to the protocol between the communicator 220 and the ANS subsystem 150. The ACK transmitter 226 transmits or sends the acknowledgement back to the application 110 directly or via the API 130 after the saving is completed. Typically, the ACK transmitter 226 transmits one single acknowledgment from the ANS subsystem 150 to the application 110 for each saving of the entire data file 115. This one single acknowledgment corresponds to the data file 115 that has been saved on the ANS subsystem 150. When the ANS subsystem 150 includes multiple ANS units, the ACK transmitter 226 may transmit the same number of acknowledgments as the number of ANS units.

The operator 230 may perform an operation on the externalized data file 115. The operation may be optional. The operation may be one of a compression 231, an encryption 232, a reversion 233, a notification 234, a garbage cleanup 235, and a caching 236. The compression 231 compresses the data file 115 according to any suitable compression algorithm. The encryption 232 encrypts the data in the data file 115 using any suitable encryption algorithm such as Advanced Encryption Standard (AES) 128 or 192 bits. The reversion 233 reverts the saving to store the data file 115 back to the application 110 or the database that is used by the application 110. The notification 234 notifies the completion of the operation by any suitable notification methods such as remote procedure call or e-mail facility. The garbage cleanup 235 cleans up the data file 115 such as removal of unreferenced items in the data file 115. The caching 236 may cache the data file 115 in the memory of the Web server 120 for frequently accessed data.

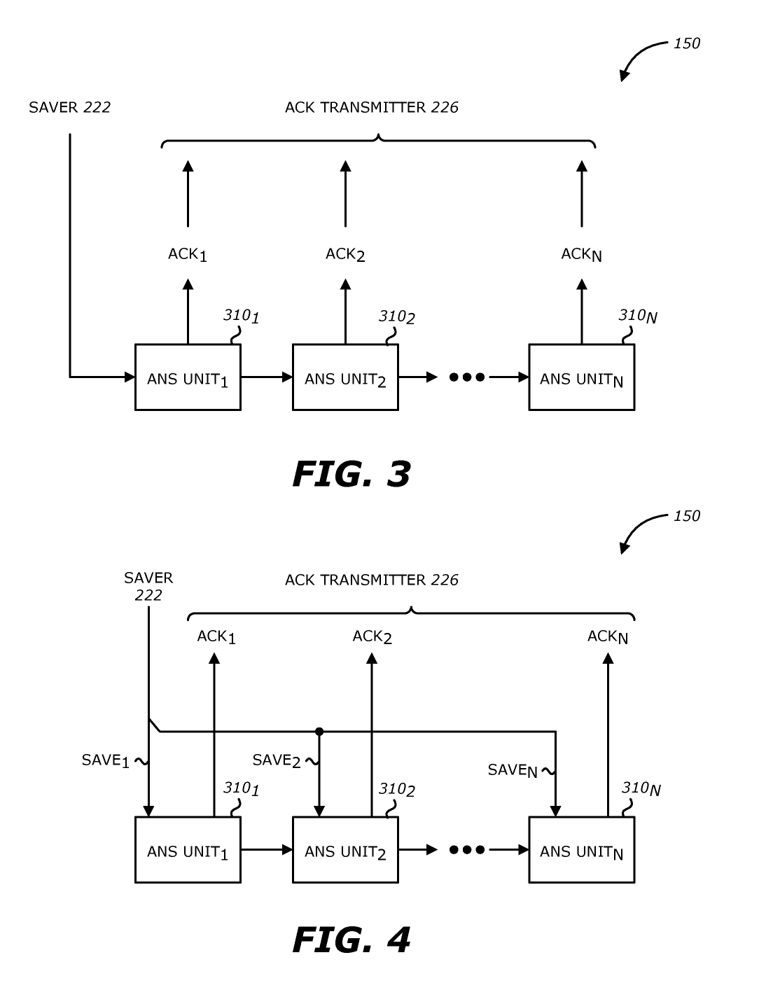

FIG. 3 is a diagram illustrating an ANS subsystem 150 using daisy chain saves according to one embodiment. In this configuration, the ANS subsystem 150 includes N ANS units 310₁ to 310_{N} connected in a daisy chain manner during save. Each of the N ANS units 310₁ to 310_{N} represents a storage device.

In this save configuration, the saver 222 saves the data file 115 in the ANS unit 1 310₁. After or during the saving of the data file 115 in the ANS unit 1 310₁, the ANS unit 1 310₁ passes the data file 115 to the next one in the chain (e.g., the ANS unit 2 310₂), and the process continues till the end of the chain (e.g., the ANS unit N 310_{N}). When a saving of the data file 115 is complete at an ANS unit, it will send an ACK signal back to the ACK transmitter 226 which will forward it to the application 110. In the end, for N ANS units, N acknowledgments will be sent back.

The process may be described as follows:

Application Save → ANS 1 → ANS 2 → . . . → ANS N
ANS 1 ACK → Application
ANS 2 ACK → Application
. . .
ANS N ACK → Application

In this configuration, there is very little knowledge of existence among the ANS units. This leads to a high scalability and redundancy in the system. In addition, there is no need for synchronization among the acknowledgements. They may come in any order.

FIG. 4 is a diagram illustrating an ANS subsystem 150 using individual saves according to one embodiment. In this configuration, the ANS subsystem 150 includes N ANS units 410₁ to 410_{N} operated independently or in parallel during save. Each of the N ANS units 410₁ to 410_{N} represents a storage device.

In this save configuration, the saver 222 saves the data file 115 in all the ANS unit 1 310₁, ANS unit 2 310₂ and the ANS unit N 310_{N} in parallel or individually by sending the SAVE 1, SAVE 2, . . . SAVE N commands together with the data file 115 to all the ANS units. This may be done using either a multicast or a broadcast method. When a saving of the data file 115 is complete at an ANS unit, it will send an ACK signal back to the ACK transmitter 226 which will forward it to the application 110. In the end, for N ANS units, N acknowledgments will be sent back.

The process may be described as follows:

Application Save → ANS 1
Application Save → ANS 2
. . .
Application Save → ANS N
ANS 1 ACK → Application
ANS 2 ACK → Application
. . .
ANS N ACK → Application

In addition to the vastly faster and simplified performance and HA, the ANS subsystem 150 may also provide ability for multisite synchronization and offline. Because in every instance of the data file externalization, there is an event that triggers a notification to the ANS unit, the ANS unit may contain the latest or most up-to-date copy of the data. In a multisite environment, each ANS unit may snapshot its data and send to another ANS and follow-up with incremental snapshots. This may be described as follows.
Client 1 [symbol] Application 4 [symbol] ANS 1 [symbol] ANS 2 at another location 4 [symbol] . . .

The ANS 2 above may then serve as both the application front-end to another client in the event that connectivity to the main application is down or failed. This may be described in the following.
Client 4 [symbol] Application 4 [symbol] ANS 1←(connectivity down)→ANS #2 ANS 2 [symbol] Client 2

In the above scenario, client 2 may get the data on ANS 2 right before connectivity is down. Typically this implies that last read-only copy.

The above scenario may be performed by the remote synchronizer 240. The remote synchronizer 240 may receive the data file 115 from the migratory 210 or from the communicator 220.

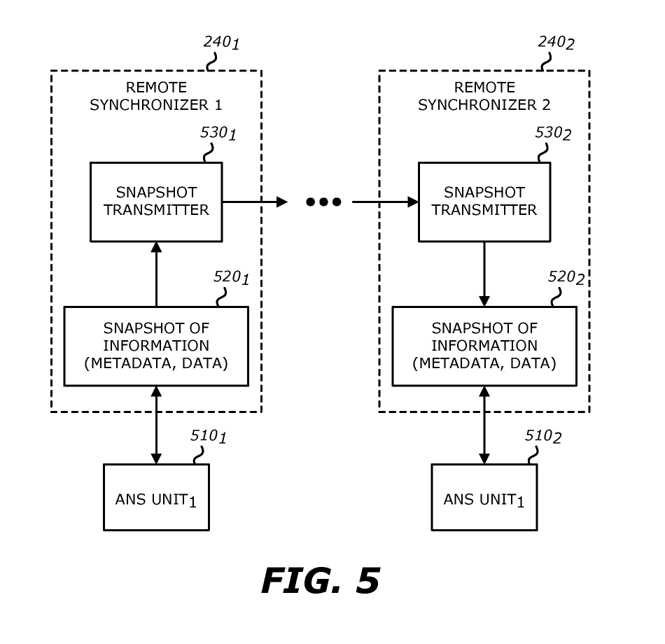

FIG. 5 is a diagram illustrating the remote synchronizer 240 according to one embodiment. This scenario involves first and second ANS units 1 and 2 510₁ and 510₂, and two remote synchronizers 240₁ and 240₂ located at the two sites. The remote synchronizer 240₁ includes a snapshot of information 520₁ and a snapshot transmitter/receiver 530₁. The remote synchronizer 240₂ includes a snapshot of information 520₂ and a snapshot transmitter/receiver 530₂.

The snapshot transmitter/receiver 530₁ transmits the snapshot of information 520₁ from the first ANS unit 510₁ to the second ANS unit 510₂. The snapshot transmitter/receiver 530₂ receives the snapshot of information 520₁ from the first ANS unit 510₁ and transfers to the snapshot of information 520₂ which is saved on the second ANS unit 510₂.

The snapshot of information may be taken as incremental snapshots. The incremental information is the difference between the new information and the existing information. By using the incremental information, significant reduction in the amount of information to be transmitted or saved may be achieved. The information may include one of data and metadata associated with the data. The remote synchronizer 240₁ may take snapshots of metadata separately from snapshots of data. It may transmit snapshots of metadata separately from snapshots of data. A user at the second site may obtain the information from the second ANS unit 510₂ when connectivity between the first and second AND units 510₁ and 510₂ is down.

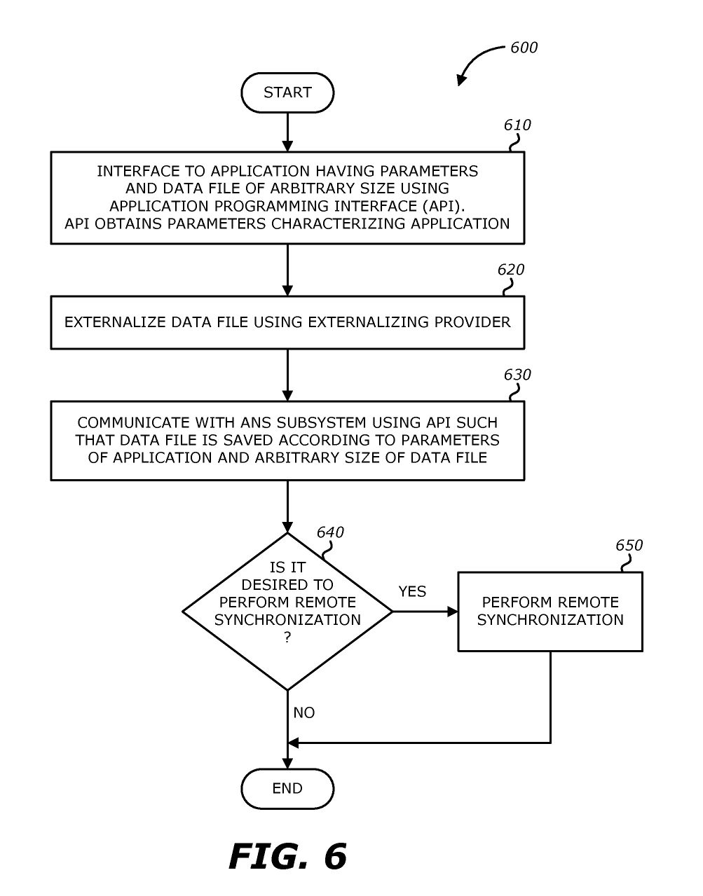

FIG. 6 is a diagram illustrating a process 600 to use the ANS according to one embodiment.

Upon START, the process 600 interfaces to an application having parameters and a data file of an arbitrary size using an application programming interface (API) (Block 610). The API may obtain the parameters characterizing the application. Then, the process 600 externalizes the data file using an externalizing provider (Block 620).

Next, the process 600 communicates with an application network storage subsystem using the API such that the data file is saved according to the parameters of the application and the arbitrary size of the data file (Block 630). Then, the process 600 determines if it is desired to perform remote synchronization (Block 640). If not, the process 600 is terminated. Otherwise, the process 600 performs a remote synchronization (Block 650) and is then terminated.

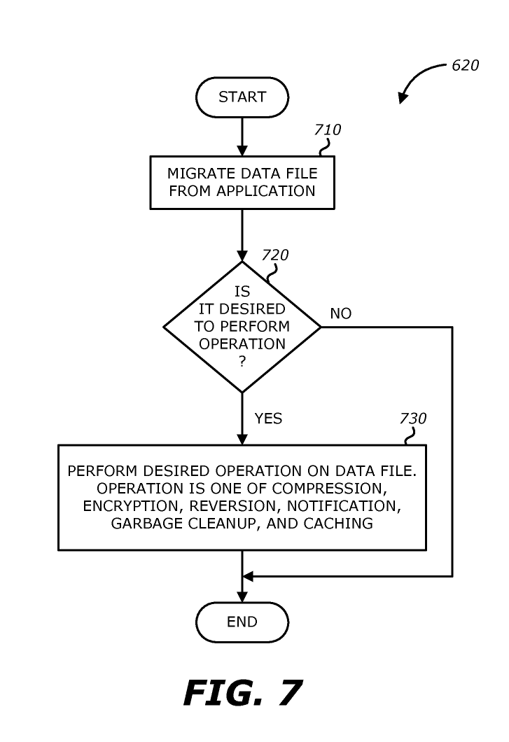

FIG. 7 is a diagram illustrating the process 620 shown in FIG. 6 to externalize according to one embodiment.

Upon START, the process 620 migrates the data file from the application (Block 710). This may be done by obtaining the parameters as parsed or extracted by the API 130 shown in FIG. 1. Since the API 130 is designed to work with the application 110, it is able to understand the application 110 and obtain the particular information regarding the data file. Then, the process 620 determines if it is desired to perform an operation (Block 720). If not, the process 620 is terminated. Otherwise, the process 620 performs the desired operation on the data file (Block 730). The operation may be one of compression, encryption, reversion, notification, garbage cleanup, and caching, as described above. The process 620 is then terminated.

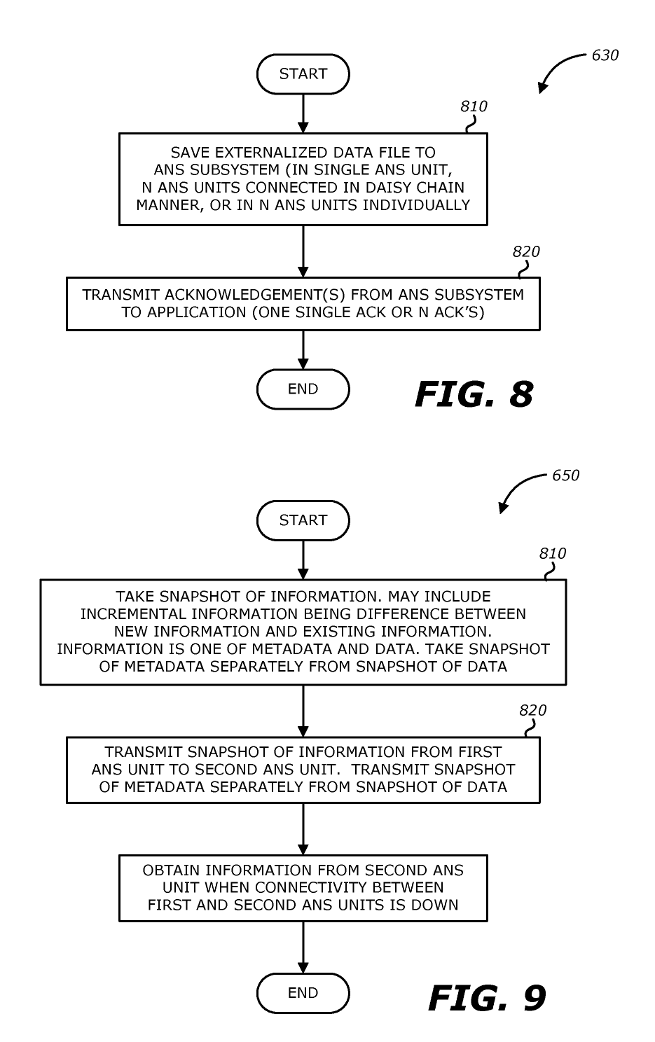

FIG. 8 is a diagram illustrating the process 630 shown in FIG. 6 to communicate according to one embodiment.

Upon START, the process 630 saves the externalized data file to the ANS subsystem (Block 810). Depending on the organization of the ANS subsystem or the desired saving mode, the process 630 may save the data file in a single ANS unit, in N ANS units connected in a daisy chain manner, or save the data file to N ANS units individually. Then, the process 630 transmits acknowledgement from the ANS subsystem to the application (Block 820). If there is one ANS unit, the process 630 transmits one single acknowledgment from the ANS subsystem to the application. The one single acknowledgment corresponds to the data file. If there are N ANS units, the process 630 transmits N acknowledgments from the N ANS units to the application. The process 630 is then terminated.

FIG. 9 is a diagram illustrating the process 650 shown in FIG. 6 for remote synchronization according to one embodiment.

Upon START, the process 650 takes a snapshot of information (Block 910). This may include taking the first snapshot or the incremental information being difference between new information and existing information. The information may be one of metadata and data. This may include taking snapshot of metadata separately from snapshot of data. Then, the process 650 transmits the snapshot of information from a first ANS unit to a second ANS unit (Block 920). This may include transmitting snapshot of metadata separately from snapshot of data. Next, a user or client may obtain the information from the second ANS unit when connectivity between the first and second AND units is down (Block 930). The process 650 is then terminated.

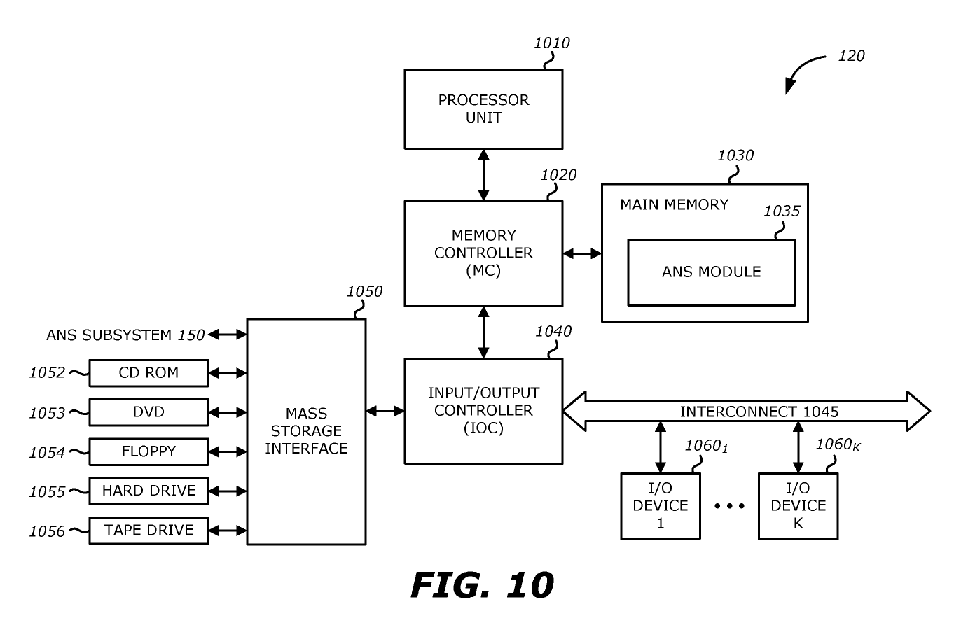

FIG. 10 is a diagram illustrating a processing system for the front end Web server 120 shown in FIG. 1 according to one embodiment. The processing system 120 includes a processor unit 1010, a memory controller (MC) 1020, a main memory 1030, an input/output controller (IOC) 1040, an interconnect 1045, a mass storage interface 1050, and input/output (I/O) devices 1060₁ to 1060_{K}. The processing system 120 may include more or less of the above components.

The processor unit 1010 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 1020 provides control and configuration of memory and input/output devices such as the main memory 1030 and the IOC 1040. The MC 1020 may be integrated into a chipset that integrates multiple functionalities such as graphics, media, host-to-peripheral bus interface, memory control, power management, etc.

The main memory 1030 stores system code and data. The main memory 930 is typically implemented with dynamic random access memory (DRAM), static random access memory (SRAM), or any other types of memories including those that do not need to be refreshed. The main memory 1030 may include multiple channels of memory devices such as DRAMs. The main memory 1030 may contain the ANS module 1035 which performs part of or all the functions of the API 130 and/or the externalizing provider 140 as discussed above.

The IOC 1040 has a number of functionalities that are designed to support I/O functions. The IOC 1040 may also be integrated into a chipset together or separate from the MC 1020 to perform I/O functions. The IOC 1040 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 1045 provides interface to peripheral devices. The interconnect 1045 may be point-to-point or connected to multiple devices. For clarity, not all interconnects are shown. It is contemplated that the interconnect 1045 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 1050 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 1052, digital video/versatile disc (DVD) 1053, floppy drive 1054, hard drive 1055, tape drive 1056, the ANS subsystem 150, and any other magnetic or optic storage devices. The mass storage device provides a mechanism to read machine-accessible media.

The I/O devices 1060₁ to 1060_{K} may include any I/O devices to perform I/O functions. Examples of I/O devices 1060₁ to 1060_{K} include controller for input devices (e.g., keyboard, mouse, trackball, pointing device), media card (e.g., audio, video, graphic), and any other peripheral controllers. The I/O devices 1060₁ to 1060_{K} may also include network interface card or devices that connect to the network for Web accesses.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any medium that may store information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method comprising:
interfacing to an application having parameters and a data file of an arbitrary size using an application programming interface (API);
externalizing the data file using a common externalizing provider; and
communicating with an application network storage (ANS) subsystem using the API such that the data file is saved according to the parameters of the application and the arbitrary size of the data file.

2. The method of claim 1 wherein interfacing comprises:
obtaining the parameters characterizing the application.

3. The method of claim 1 wherein externalizing comprises:
migrating the data file from the application.

4. The method of claim 1 wherein externalizing further comprises:
performing an operation on the data file, the operation being one of compression, encryption, reversion, notification, garbage cleanup, and caching.

5. The method of claim 1 wherein communicating comprises:
saving the externalized data file to the ANS subsystem; and
transmitting one single acknowledgment from the ANS subsystem to the application, the one single acknowledgment corresponding to the data file.

6. The method of claim 1 wherein communicating comprises:
saving the data file to N ANS units in the ANS subsystem in a daisy chain manner; and
transmitting N acknowledgments from the N ANS units to the application.

7. The method of claim 1 wherein communicating comprises:
saving the data file to N ANS units in the ANS subsystems individually; and
transmitting N acknowledgments from the N ANS units to the application.

8. The method of claim 1 further comprising:
taking a snapshot of information; and
transmitting the snapshot of information from a first ANS unit to a second ANS unit.

9. The method of claim 7 wherein taking the snapshot of information comprises:
taking incremental information being difference between new information and existing information.

10. The method of claim 6 wherein the information includes one of data and metadata associated with the data.

11. The method of claim 8 wherein taking the snapshot of information comprises:
taking snapshot of metadata separately from snapshot of data.

12. The method of claim 8 wherein transmitting the snapshot of information comprises:
transmitting snapshot of metadata separately from snapshot of data.

13. The method of claim 8 further comprising:
obtaining the information from the second ANS unit when connectivity between the first and second AND units is down.

14. A system comprising:
an application programming interface (API) to interface to an application having a data file of an arbitrary size, the application having parameters characterizing the application;
an externalizing provider coupled to the API to externalize the data file; and
an application network storage (ANS) subsystem coupled to the externalizing provider to save the data file according to the parameters of the application and the arbitrary size of the data file.

15. The system of claim 14 wherein the API obtains the parameters from the application.

16. The system of claim 14 wherein the externalizing provider comprises:
a migrator to migrate the data file from the application; and
a communicator to communicate with the ANS subsystem.

17. The system of claim 14 wherein the externalizing provider further comprises:
an operator to perform an operation on the data file, the operation being one of compression, encryption, reversion, notification, garbage cleanup, and caching.

18. The system of claim 16 wherein the communicator comprises:
a saver to save the externalized data file to the ANS subsystem; and
an acknowledgment transmitter to transmit one single acknowledgment from the ANS subsystem to the application, the one single acknowledgment corresponding to the data file.

19. The system of claim 14 wherein the communicator comprises:
a saver to save the data file to N ANS units in the ANS subsystem in a daisy chain manner; and
an acknowledgment transmitter to transmit N acknowledgments from the N ANS units to the application.

20. The system of claim 14 wherein the communicator comprises:
a saver to save the data file to N ANS units in the ANS subsystems individually; and
an acknowledgment transmitter to transmit N acknowledgments from the N ANS units to the application.

21. The system of claim 14 wherein the externalizing provider further comprises:
a remote synchronizer to take a snapshot of information and transmit the snapshot of information from a first ANS unit to a second ANS unit.

22. The system of claim 20 wherein the remote synchronizer takes incremental information being difference between new information and existing information.

23. The system of claim 21 wherein the information includes one of data and metadata associated with the data.

24. The system of claim 21 wherein the remote synchronizer takes snapshot of metadata separately from snapshot of data.

25. The system of claim 21 wherein the remote synchronizer transmits snapshot of metadata separately from snapshot of data.

26. The system of claim 21 wherein a user obtains the information from the second ANS unit when connectivity between the first and second ANS units is down.

27. An article of manufacture comprising:
a machine-accessible medium including data that, when accessed by a machine, cause the machine to perform operations comprising:
interfacing to an application having parameters and a data file of an arbitrary size using an application programming interface (API);
externalizing the data file using a common externalizing provider; and
communicating with an application network storage (ANS) subsystem using the API such that the data file is saved according to the parameters of the application and the arbitrary size of the data file.

28. The article of manufacture of claim 16 wherein the data causing the machine to perform communicating comprise data that, when executed by the machine, causes the machine to perform operations comprising:
saving the externalized data file to the ANS subsystem; and
transmitting one single acknowledgment from the ANS subsystem to the application, the one single acknowledgment corresponding to the data file.

29. The article of manufacture of claim 21 wherein the data further comprise data that, when executed by the machine, causes the machine to perform operations comprising:
taking a snapshot of information; and
transmitting the snapshot of information from a first ANS unit to a second ANS unit.

30. The article of manufacture of claim 21 wherein the data causing the machine to perform taking a snapshot of information comprise data that, when executed by the machine, causes the machine to perform operations comprising:
taking incremental information being difference between new information and existing information.
